(19) United States
(12) Patent Application Publication
(10) Pub. No.: US 2014/0272007 A1
(43) Pub. Date: Sep. 18, 2014

(54) Snack Food Having Large Surface Inclusions

(71) Applicant: FRITO-LAY NORTH AMERICA, INC., Plano, TX (US)

(72) Inventors: Hanny KANAFANI, Plano, TX (US); Bernadette J. Domingo, Rockton, IL (US); Jack William Maegli, Beloit, WI (US); Destanie Amber Schneider, Beloit, WI (US)

(73) Assignee: FRITO-LAY NORTH AMERICA, INC., Plano, TX (US)

(21) Appl. No.: 13/836,480

(22) Filed: Mar. 15, 2013

(51) Int. Cl. A23L 1/217

(52) U.S. Cl. CPC A23L 1/217
USPC 426/92; 426/102; 426/93

(57) ABSTRACT

A snack food having large food flakes whereby the food flakes are substantially adhered to the food substrate by an adhesive. The food substrate may be any savory shelf-stable food known in the art such as a chips, pretzels, crispy bread products, popcorn, or nuts. A blend of the food flakes and the adhesive in its liquid form is applied to a food substrate. The topped food substrate is then subjected to changed process conditions to harden the adhesive, forming a bond between the food flakes and the food substrate.

### BACKGROUND OF THE INVENTION

1. Technical Field

The present invention relates to a snack food product with large food flakes adhered to the surface. The food flakes may be pieces of vegetables, meats, cheeses, herbs, or spices.

2. Description of Related Art

Seasoning powders are often added to snack foods in order to provide taste and likeability. Snack foods include potato chips, tortilla chips, extruded snacks, pretzels, bread snacks, popcorn, and numerous other foodstuffs. Seasonings used, usually in a powdered form, have included salt, cheese and/or other dairy powders, tomato powder, chili powder, garlic powder, and onion powder, among many others. However, there is often an undesirable separation of the seasoning powder from the snack food. The separation occurs because of insufficient adhesion of the seasoning powders to the snack food. The problem of separation increases with the size and weight of the individual particles of the seasoning blend, and is most pronounced when large seasoning particles are used.

One way this problem has been approached in the past was by using oil as an adhesive to adhere particulate seasonings to a base or substrate. For example U.S. Pat. No. 6,534,102 B2, issued to Kazemzadeh, discloses a seasoning bit that, following extrusion and cooking is immersed into an oil and seasoning slurry at an elevated temperature. The product is then dry-coated with seasonings or sprayed with hot or room temperature oils and fats either carrying seasonings or the seasonings are applied as dusting on the surface while the oil and fats are used to adhere the seasoning to the surface. One drawback to using only oil, however, is that the adhesive strength of traditional oil mixes is not strong enough to adhere large three-dimensional bits to a substrate surface. In certain applications, large three-dimensional bits are desirable because they enable packaged snack chips to emulate another topped product including, but not limited to a pizza with toppings, a nacho chip, or a tostada.

Another prior art composition used to adhere particulates to a food product is U.S. Pat. No. 3,689,290 issued to Blackenstock et al which discloses using a coating agent comprised of dry corn syrup solids to adhere small particle sizes of food toppings to a substrate. The Blackenstock Patent discloses a particle size of the food topping as being 12-100 mesh, which corresponds to a particle size range of 0.150 to 1.68 millimeters (0.0059 to 0.0661 inches). Again, these are relatively small particle sizes that are being adhered to a substrate. The adhesive is not strong enough to adhere a substantial amount of larger three-dimensional particles to the chip.

U.S. Patent Application 2002/0187220 A1 discloses an edible particulate adhesive comprising maltodextrin, an edible surfactant, a solvent, a polysaccharide, and a modified starch. The invention, however, is clearly aimed at very small particulate adhesion.

The invention indicates the preferred particle size is less than 650 micrometers. Thus, this invention also fails to adhere relatively large bits to a chip.

Another prior art composition used to adhere flavorings to a foodstuff is illustrated by European Patent EP 0 815 741 A2 which discloses a hot melt composition comprising a starch, such as corn syrup, maltodextrin, or an amylase-treated starch, and a plasticizer, such as a polyol or a polyacetic acid. Like the other inventions, this invention was also designed to adhere powdery-type particulate additives to foodstuffs such as salt, sugar, cheese powder, and ranch seasonings. Like other inventions in the prior art, it also fails to adhere relatively large bits to chips.

U.S. Pat. No. 7,074,445 discloses a method for adhering large seasoning bits to a food substrate wherein seasoning bits are coated with vegetable oil as a temporary adhesive to adhere a dry adhesive comprising corn syrup solids to the seasoning bits. The coated seasoning bits are applied to a substrate and sent through an oven or series of ovens to heat the dry adhesive and trigger its glass transition stage, so that the adhesive flows down around the bit. As the substrates are cooled, the adhesive undergoes another glass transition phase back to a solid which hardens the adhesive and adheres the bit to the food substrate surface. While effective at adhering large particles to a food substrate, the adhesive used has several drawbacks in that: a) it requires further processing steps after application, incurring significant additional capital; b) the heating required to trigger its glass transition causes formation of undesirable chemicals such as acrylamide; and c) it typically includes ingredients (e.g., corn syrup solids, maltodextrins, polysaccharides) that impart a sweet taste, which is undesirable for savory snack products.

Consequently a need exists for a method to adhere large food particulates, bits, fragments, flakes, or morsels to a food substrate that does not present the drawbacks previously described. The method should allow a snack food to demonstrate the characteristic look, texture, and taste of an emulated topped food product, yet be highly resistant to separation. The method should be adaptable to a product manufacturing line wherein the addition of the large particles occurs at a step after substantial cooking of the underlying food substrate and does not require further heating of the food substrate after the application of the adhesive.

### SUMMARY OF THE INVENTION

The present invention provides a savory and hearty snack food product with food flakes on its surface that provide a visual impact for consumers. The adhesive used herein allows large food flakes to be adhered to a food substrate. In one embodiment, the adhesive used is a dairy-based, oil-joining adhesive. The food substrate may be any savory shelf-stable snack food product known in the art, and the food flakes used can be pieces of vegetables, meats, cheeses, herbs or spices that complement the food substrate. The food pieces may be pieces cut from the food as defined by local regulations (“natural” flakes) or formed from preparations to mimic the food (“formed” flakes).

This invention provides a method of producing the snack food products whereby a dairy-based adhesive is heated to above its phase transition temperature to obtain a liquefied adhesive, blended with the food flakes and applied to the food substrates. The topped food substrates are then cooled below the phase transition temperature of the adhesive, which hardens the adhesive and substantially adheres the food flakes to the food substrate. An apparatus for practicing the inventive method is also disclosed.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a flowchart of one embodiment of the inventive method; and

FIG. 2 is a schematic representation of one embodiment of the apparatus for the inventive method.

### DETAILED DESCRIPTION OF THE INVENTION

Several embodiments of Applicants' invention will now be described with reference to the drawings. Unless otherwise noted, like elements will be identified by identical numbers throughout all figures. The invention illustratively disclosed herein suitably may be practiced in the absence of any element which is not specifically disclosed herein.

The present invention provides a snack food product with large food flakes adhered to its surface, a method for making the snack food product, and an apparatus for practicing the method. The adhesive used herein allows larger food flakes than that disclosed in the prior art to be adhered to the surface of a food substrate. The resulting snack food product is a savory and hearty snack topped with food flakes that provide a visual impact for consumers and deliver taste and appearance.

The food substrate can be any savory snack food product known in the art, such as tortilla chips, potato chips, corn chips, extruded snacks, pretzels, crispy breads, popcorn, nuts, or nut clusters. In one embodiment, the food substrate is a savory shelf-stable snack food with a moisture content of less than about 3% by weight. The food flakes chosen can be any type of food, such as vegetable pieces, meat pieces, herbs, spices, or cheese shreds, or any combination of those, that complement the flavor of the food substrate or contributes to the flavor and appearance of the desired final snack food product. As used herein, the terms “flakes,” “pieces,” and “bits” are used interchangeably. The food flakes may be natural, meaning that the flakes are obtained from the natural food as defined by local regulations, or formed, meaning that the flakes are shaped from preparations from the natural food or a formulation made to replicate the natural food. Examples of food flakes that can be used are tomato pieces, carrot pieces, olive pieces, mushroom pieces, onion pieces, beet pieces, jalapeno pieces, green chili pieces, sweet pepper pieces, bacon pieces, chicken pieces, beef pieces, fish pieces, calamari pieces, shellfish pieces, caviar pieces, cheddar cheese shreds, mozzarella cheese shreds, gouda cheese shreds, spicy pepper flakes, chili flakes, dill flakes, parsley flakes, basil flakes, garlic pieces, paprika flakes, rosemary flakes, mint flakes, black pepper pieces, curry leaf flakes, caraway seeds, sesame seeds, or poppy seeds. The food flakes may also be culinary preparations or cuisine recipes, such as lasagna, pizza, or grilled meats, processed into flakes or pieces. A complementary seasoning powder may also be adhered to the food substrate to provide a fuller flavor for the final snack food product.

An embodiment of the inventive method will now be described with reference to FIG. 1. An adhesive is provided 110. In one embodiment, the adhesive used is a dairy-based adhesive, referred to herein as an oil-joining adhesive. The oil-joining adhesive is comprised of fractions of palm oil, kernel oil, or a combination thereof, blended with a cheese-based mixture comprised of cheddar cheese, whey, hydrogenated vegetable oil, butter, calcium stearate, buttermilk, salt, disodium phosphate, sunflower oil, natural flavors, and artificial flavors. The cheddar cheese is made of pasteurized milk, cheese cultures, salt, and enzymes, and the hydrogenated vegetable oil can be canola oil, cottonseed oil, or soybean oil. The oil fractions comprise about 45% to about 55% of the adhesive and the cheese-based mixture comprises about 45% to about 55% of the adhesive. The oil-joining adhesive has a phase transition temperature between about 95° F. and about 165° F. Thus, the oil joining adhesive is solid at ambient conditions so it must be heated above its phase transition temperature to obtain a liquefied adhesive. In one embodiment, the oil-joining adhesive is heated to between about 95° F. and about 165° F., more preferably between about 105° F. and about 125° F.

In one embodiment, the adhesive used is a carbohydrate-based adhesive, herein referred to as water-joining adhesive. Water joining adhesives are typically comprised of a blend of starches, dextrins, gums, high fructose corn syrup, sugars, and surfactants, as well as other compounds. An example of a commercially available water joining adhesive is Sherex® from Kerry Inc. or N-Tack® from Ingredion Inc. Water-joining adhesives are designed to develop adhesive properties when heated above their glass transition temperature and then cooled, or when hydrated and subsequently dehydrated. However, the heating or drying step required for carbohydrate-based adhesives have significant adverse effects including increased capital and undesirable chemical by-products such as acrylamide.

A plurality of food flakes are provided 120. Food flakes having dimensions of about 4 to 20 millimeters in length, about 3 to 6 millimeters in width, about 2 to 4 millimeters in thickness, and a bulk density of about 1.5 to about 4.0 g/cc are capable of being adhered to a food substrate with the present invention. The adhesive and food flakes are blended 130 to form an adhesive-flake blend. In one embodiment, the adhesive-flake blend is comprised of, by weight of the blend, about 1 to 46% adhesive and about 0 to 54% food flakes. The food flakes may be any combination of vegetable flakes, meat flakes, herb flakes, spice flakes, or cheese shreds. In one embodiment, the food flakes of the adhesive-flake blend comprise about 0 to 27% by weight cheese shreds. In another embodiment, the adhesive-food flake blend is comprised of, by weight of the blend, about 1 to 69% adhesive and about 0 to 31% food flakes. The food flakes should be thoroughly coated with the adhesive to promote optimum adherence to the food substrate. Any excess adhesive is preferably removed during this blending step 130.

A plurality of food substrates, each having a surface to apply food flakes, are provided 150 to a seasoning drum or other mixing device. The adhesive-flake blend is transferred 140 to the seasoning drum and applied 160 to the plurality of food substrates. The seasoning drum tumbles 170 the food substrates and the adhesive-flake blend to sufficiently cover the entire surface of the food substrates with the adhesive-flake blend, forming topped food substrates. A seasoning powder is optionally applied 180 to the topped food substrates.

The adhesive is then solidified 190 on the topped snack food products, thereby substantially adhering the food flakes to the food substrates. In an embodiment in which an oil-joining adhesive is used, the topped food substrates are cooled to below the phase transition temperature of the adhesive such that the adhesive solidifies and substantially adheres the food flakes and seasoning powder to the food substrates. The cooling step may be accomplished by exposing the snack products to ambient conditions or introducing cool air into the seasoning drum, where the cool air has a temperature less than about 95° F. In an embodiment where a water joining adhesive is used, the topped snack food products are heated to about 210° F. to about 270° F. The heating serves to activate the water joining adhesive, thereby substantially adhering the food flakes and seasoning powder to the food substrates.

The final snack food product obtained by the inventive method thus contains a food substrate, solidified adhesive, food flakes, and seasoning powder. In one embodiment, the topped snack food product comprises, based on the weight of the topped snack food product, about 50 to 95% food substrate, about 5 to 55% adhesive-flake blend, and about 0 to 10% seasoning powder. The adhesive-flake blend comprises about 0 to 46% adhesive and about 0 to 54% food flakes. In one embodiment, the adhesive-flake blend comprises about 0 to 27% cheese shreds. In another embodiment, the topped snack food product comprises, based on the weight of the topped snack food product, about 70 to 85% food substrate, about 15 to 32% adhesive-flake blend, and about 0 to 4% seasoning powder. The adhesive-flake blend comprises about 1 to 69% adhesive and about 0 to 31% food flakes. In one embodiment, the adhesive-flake blend comprises about 0 to 12% cheese shreds.

An embodiment of an apparatus used to practice the inventive method will now be described. FIG. 2 depicts a schematic representation of an embodiment of the apparatus. A hopper 210 for holding and dispensing food flakes is in fluid communication with a blending device 230. While a hopper is described in this embodiment, any equivalent device may be used, including but not limited to a gravimetric dispenser, a volumetric dispenser, or a batch weigher. A vessel 220 for holding and dispensing the adhesive is in fluid communication with the blending device 230 via a first transport tube 225. The vessel 220 may be any vessel known in the art; in an embodiment using an oil-joining adhesive, the vessel 220 is capable of holding a liquid at a temperature up about 200° F. such as a jacketed kettle, direct heated tank, or a circulating tank series, equipped with a direct or indirect mixing device. The blending device 230, in one embodiment, is a pipe with an auger extending longitudinally within the pipe for thoroughly mixing the food flakes with the adhesive as the materials are moved downstream. The blending device 230 could be any equivalent device, including but not limited to, pipes or channels retrofitted with air or mechanical stirrers or flow interrupters to ensure that the food flakes remain uniformly dispersed in the adhesive-flake blend.

In one embodiment, the blending device 230 also includes a means for removing excess adhesive from the adhesive-flake blend. The means for removing excess adhesive, in one embodiment, is a series of perforations along the length of the blending device 230. The perforations are designed such that as the adhesive-flake blend travels through the blending device 230 over the perforations, the coated food flakes are retained in the blending device 230 while the excess adhesive falls through. A funnel system collects the excess adhesive removed from the blending device 230, which can be recycled back to the adhesive vessel 220. The size and number of perforations in the blending device 230 are dependent on the amount of adhesive to be removed and the type of food flakes. The funnel system can be an enclosed system with vacuum capability to more effectively remove the adhesive.

An applicator 240, in fluid communication with the blending device 230 via a second transport tube 235, is located within a seasoning drum 250. The seasoning drum 250 is a cylindrical device that rotates, continuously tumbling or turning over the food substrate traveling within the drum so the substrate receives the adhesive-flake blend and seasoning on the substrate's total surface area. A substrate delivery system 260 for providing food substrates to the seasoning drum 250 and a seasoning dispenser 270 are also located within the seasoning drum 250. The substrate delivery system 260 is located upstream from the applicator 240 in the seasoning drum 250. The substrate delivery system 260 conveys the food substrates from upstream or offline processing, which may be any one of a number of standard methods known in the art, and can be any means known in the art such as a static or vibratory conveyor. The seasoning dispenser 270 is located downstream from the applicator 240 in the seasoning drum 250, and dispenses seasoning powder, which is delivered from a hopper (not shown) in fluid communication with the seasoning dispenser 270, onto the food substrates as they proceed through the seasoning drum 250. A substrate removal system 290 is connected to the seasoning drum 250 for removal of the topped snack food products and delivery of the snack food products for further processing or to a packaging unit (not shown). The substrate removal device 290 may be any means known in the art such as a static or vibratory conveyor.

In an embodiment in which an oil-joining adhesive is used, a cool air injection device 280 is located within the seasoning drum 250 downstream from the seasoning dispenser 270 for injecting cooled air into the tumbler for solidifying the adhesive. Further, the vessel 220, first transport tube 225, blending device 230, second transport tube 235, and applicator 240 are heat-traced. As used herein, heat-traced means that the equipment is heated and maintained at a set temperature range, which is determined based upon the flakes used. The vessel 220, first transport tube 225, blending device 230, second transport tube 235, and applicator 240 must be heat-traced when the oil-joining adhesive is used to maintain the adhesive at a temperature above the adhesive's phase transition temperature so that the adhesive remains in its liquefied state. In an embodiment using an water joining adhesive, the apparatus also comprises an oven or direct heating elements like infra-red or electric heating panels (not shown) for heating the topped snack food products to activate the adhesive. The topped snack food products are delivered to the oven by the substrate removal system 290.

In one embodiment, the applicator 240 is an atomizing nozzle, which uses air pressure to disperse the adhesive-flake blend uniformly over the food substrates traveling through the seasoning drum 250. The atomizing nozzle is open, so the application rate of the adhesive-flake blend is controlled by the flow rate through the blending device 230. The applicator 240 could also be an air-assisted nozzle in which air pushes the adhesive-flake blend though a manifold system and out a controlled or open pipe over the food substrates. With an air-assisted nozzle applicator 240, the application rate of the adhesive-flake blend is controlled by the air pressure introduced into the manifold. In another embodiment, the applicator 240 is a scarf plate, which may be static or vibratory, with air orifices. The adhesive-flake blend is transferred to the scarf plate and air provided through the air orifices pushes the blend down and off the scarf plate onto the food substrates. In another embodiment, the applicator 240 is a combination of the atomizing nozzle and scarf plate. The atomizing nozzle disperses the adhesive-flake blend onto the scarf plate, where air provided through the air orifices pushes the blend off the scarf plate and onto the food substrates. In another embodiment, the scarf plate is fitted with a trough at the terminal of the scarf plate. The trough is covered with a perforated lid that is contiguous with the terminal of the scarf plate. As the adhesive-flake blend flows off of the scarf plate, it flows over the perforated lid. Any remaining excess adhesive falls through the perforations in lid into the trough, and the flakes continue to flow off of the lid and onto the food substrates.

### EXAMPLE

A “caprese” style snack food product was made using a potato chip on which tomato flakes, basil flakes, and smoked mozzarella cheese shreds, along with a seasoning blend of garlic powder, onion powder, and salt, were adhered. To make this snack food product, 20 grams of an oil-joining adhesive was heated to about 155-165° F. to obtain a liquefied adhesive. The liquefied adhesive was blended with 2 grams of tomato flakes, 1 grams of basil flakes, and 3 grams of smoked mozzarella cheese shreds to form an adhesive-flake blend. The adhesive-flake blend was applied by atomizing nozzle over the food substrates in a seasoning drum. The seasoning blend of garlic powder, onion powder, and salt was dispensed by a seasoning dispenser over the food substrates in the seasoning drum. The topped snack food product was cooled, hardening the adhesive and substantially adhering the food flakes to the food substrate. The final snack food product was comprised of about 70% food substrate, about 20% adhesive, about 3% tomato and basil flakes, about 3% cheese shreds, and about 4% seasoning blend.

While this invention has been particularly shown and described with reference to preferred embodiments, it will be understood by those skilled in the art that various changes in form and detail may be made therein without departing from the spirit and scope of the invention. The inventors expect skilled artisans to employ such variations as appropriate, and the inventors intend the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

We claim:

1. A packaged, topped snack food comprising, in proportions based upon the total weight of the topped snack food:
about 50 to 95% by weight of a food substrate;
about 5 to 55% by weight of an adhesive-flake blend, wherein said food flakes have dimensions substantially between about 4-20 mm in length, about 3-6 mm in width, about 2-4 mm in thickness, and bulk density of 1.5-4.0 g/cc, wherein said adhesive-flake blend comprises:
about 0 to 54% by weight food flakes; and
about 1 to 46% by weight adhesive, wherein said adhesive provides an adhering means for adhering said food flakes to said food substrate; and
about 0 to 10% by weight seasoning powder.

2. The snack food of claim 1 wherein said food substrate comprises a savory shelf-stable food having a moisture content less than about 3%.

3. The snack food of claim 2 wherein said savory shelf-stable food is selected from a group consisting of tortilla chips, potato chips, corn chips, extruded snacks, pretzels, crispy breads, popcorn, nuts, or nut clusters.

4. The snack food of claim 1 wherein said food flakes of said adhesive-flake blend comprise about 0 to 27% by weight cheese shreds.

5. The snack food of claim 1 wherein said food flakes comprise one or more vegetable flakes, meat flakes, herb flakes, spice flakes, or cheese shreds.

6. The snack food of claim 1 wherein said food flakes at least one selected from the group consisting of tomato pieces, carrot pieces, olive pieces, mushroom pieces, onion pieces, beet pieces, jalapeno pieces, green chili pieces, sweet pepper pieces, bacon pieces, chicken pieces, beef pieces, fish pieces, calamari pieces, shellfish pieces, caviar pieces, cheddar cheese shreds, mozzarella cheese shreds, gouda cheese shreds, spicy pepper flakes, chili flakes, dill flakes, parsley flakes, basil flakes, garlic pieces, paprika flakes, rosemary flakes, mint flakes, black pepper pieces, curry leaf flakes, caraway seeds, sesame seeds, and poppy seeds.

7. The snack food of claim 1 wherein said food flakes are natural.

8. The snack food of claim 1 wherein said food flakes are formed.

9. The snack food of claim 1 wherein said adhesive comprises oil fractions blended with a cheese-based mixture, wherein said oil fractions comprise palm oil, kernel oil, or a combination thereof, and further wherein said cheese-based mixture comprises cheddar cheese, whey, hydrogenated vegetable oil, butter, buttermilk, salt, sunflower oil, and natural flavors.

10. The snack food of claim 9 wherein said oil fractions comprise about 45-55% by weight of said adhesive and said cheese-based mixture comprises about 45-55% by weight of said adhesive.

11. The snack food of claim 1 comprising, in proportions based upon the total weight of the topped snack food:
about 70 to 85% by weight of a food substrate;
about 15 to 32% by weight of an adhesive-flake blend, wherein said adhesive-flake blend comprises:
about 0 to 31% by weight food flakes; and
about 1 to 69% by weight adhesive wherein said adhesive provides an adhering means for adhering said food flakes to said food substrate; and
about 0 to 4% by weight seasoning powder.

10. The snack food of claim 11 wherein said food flakes of said adhesive-flake blend comprise about 0 to 12% by weight cheese shreds.
